(19) United States
(12) Patent Application Publication
(10) Pub. No.: US 2013/0283283 A1
(43) Pub. Date: Oct. 24, 2013

(54) PORTABLE ELECTRONIC DEVICE AND CONTROL METHOD THEREFOR

(71) Applicant: HTC Corporation, Taoyuan County (TW)

(72) Inventors: Hui-Wen Wang, Taoyuan (TW); Yih-Feng Kao, Taoyuan (TW); Wen-Chih Peng, Taoyuan (TW); Kae-Cherng Yang, Taoyuan (TW)

(21) Appl. No.: 13/923,409

(22) Filed: Jun. 21, 2013

Related U.S. Application Data
(63) Continuation-in-part of application No. 13/299,408, filed on Nov. 18, 2011.

(30) Foreign Application Priority Data
Jan. 13, 2011 (TW) 100101309

(51) Int. Cl. G06F 9/46

(52) U.S. Cl. CPC G06F 9/46
USPC 718/102

(57) ABSTRACT

An application usage history of a plurality of applications installed on the portable electronic device is logged. The application usage history includes any combination of when the applications are launched, where the application are launched and application launch patterns. Any combination of a current time information, a current location information and a current application launch pattern are obtained. The applications are selected to provide the application list including at least one application that is possible to be launched according to the application usage history and any combination of the current time information, the current location information and the current application launch pattern.

This application is a continuation-in-part application of U.S. patent application Ser. No. 13/299,408 filed Nov. 18, 2011 which claims the benefit of Taiwan application Serial No. 100101309, filed Jan. 13, 2011, the disclosure of which are incorporated by reference herein in its entirety.

### BACKGROUND

1. Technical Field

The disclosed embodiments relate in general a portable electronic device and a control method therefor.

2. Description of the Related Art

In recent years, research in the field of portable electronic device, such as touch phone, personal digital assistant (PDA) and mobile phone, has gained remarkable progress. Normally, the portable electronic device provides a variety of applications for users.

In general, in order for users to use the applications, the applications (APP) of the portable electronic device are normally arranged in a hierarchical manner and are in the form of a menu for users' observation and selection. However, when a user would like to activate an application, he or she is required to go through several hierarchies of menus before the desired desired application can be located.

For example, when the user would like to activate a browser to read news, the required procedures may include finding out browser application icon in the menu. If the user install more applications, it is bothersome for the user to find out the application icon he/she wants in the lots of icons.

Therefore, there is a need to increase the convenience for the user to find out application(s) he/she desires.

Besides, data sync is also important for portable electronic devices. Data sync actions include e-mail sync, social network sync and so on. In e-mail sync, people use the portable electronic device to receive mails from a mail server through Internet. Data sync actions consume the limited battery power of the portable electronic device. So, a good data sync scheduling, which prevents unnecessary power consumption and unnecessary data sync, plays an important role to let the user have good experience.

### SUMMARY

The disclosure is directed to a portable electronic device and a control method thereof, which develops a user's app-launched behavior learning system to log when and/or where the user launches application and/or application launch patterns and will predict user's app-launched behaviors to automatically provide an application list which list the applications the user likely launch in this time and/or at this place and/or in this application launch pattern.

The disclosure is directed to a portable electronic device and a control method thereof, which provides a data-sync scheduling system based on user behavior and signal connection quality.

According to one embodiment, a control method for providing an application list on a portable electronic device is provided. The control method includes: logging an application usage history of a plurality of applications installed on the portable electronic device, the application usage history including any combination of when the applications are launched, where the application are launched and application launch patterns; obtaining any combination of a current time information, a current location information and a current application launch pattern; and selecting from the applications to provide the application list including at least one application that is possible to be launched according to the application usage history and any combination of the current time information, the current location information and the current application launch pattern.

According to another embodiment, a control method for a portable electronic device includes: logging a data sync application usage history of a plurality of data sync applications installed on the portable electronic device, the data sync application usage history including any combination of when and where the data sync applications are launched; mining the data sync application usage history for finding out dependent probabilities for the data sync applications; scheduling data sync actions of the portable electronic device based on the mining; and if time for the scheduled data sync actions arrives, deciding whether to perform the schedule data sync actions or not based on a signal connection quality of the portable electronic device.

According to still another embodiment, a portable electronic device comprises: a log subsystem logging an application usage history of a plurality of applications installed on the portable electronic device, the application usage history including any combination of when the applications are launched, where the application are launched and application launch patterns; means for obtaining any combination of a current time information, a current location information and a current application launch pattern; and a predicting subsystem selecting from the applications to provide the application list including at least one application that is possible to be launched according to the application usage history and any combination of the current time information, the current location information and the current application launch pattern.

According to yet another embodiment, a portable electronic device includes: a logging subsystem, logging a data sync application usage history of a plurality of data sync applications installed on the portable electronic device, the data sync application usage history including any combination of when and where the data sync applications are launched; a mining subsystem mining the data sync application usage history for finding out dependent probabilities for the data sync applications; a dynamic scheduling subsystem, subsystem, scheduling data sync actions of the portable electronic device based on the mining; and a data-sync decision subsystem, if time for the scheduled data sync actions arrives, deciding whether to perform the schedule data sync actions or not based on a signal connection quality of the portable electronic device.

### BRIEF DESCRIPTION OF THE DRAWINGS

FIG. 1 shows a functional block diagram for a portable electronic device according to an embodiment of the application.

FIGS. 2A and 2B show analysis result examples of the analysis subsystem.

FIG. 3 shows a functional block diagram of a portable electronic device according to a second embodiment of the application.

FIGS. 4A and 4B show data mining result from the mining subsystem.

FIG. 5 shows data-sync decision flow chart according to the embodiment of the application.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices, if any, are schematically shown in order to simplify the drawing.

The present application relates to a portable electronic device and a control method thereof. It shall be appreciated that, description of the following embodiments is only for purpose of illustration rather than to limit the scope of the present application. Moreover, in the following embodiments and the attached drawings, elements unrelated to the present application are omitted from depiction; and dimensional relationships among individual elements in the attached drawings are illustrated only for ease of understanding but not to limit the actual scale.

In an embodiment of the application, a portable electronic device includes a user app-launched behavior learning system which logs any combination of when the user launches applications, where the user launches applications and application launch patterns. After prediction, an application list (which shows a prediction result) is shown on a display screen of the portable electronic device so that user is convenient to choose application from the application list. The application list lists applications which are predicted as being likely chosen by the user.

In another embodiment of the application, a portable electronic device includes a data sync scheduling based on user behavior and/or based on signal connection quality. By this, data sync will be scheduled based on user behavior. Also, data sync will not be performed if the signal connection quality is not good enough.

### First Embodiment

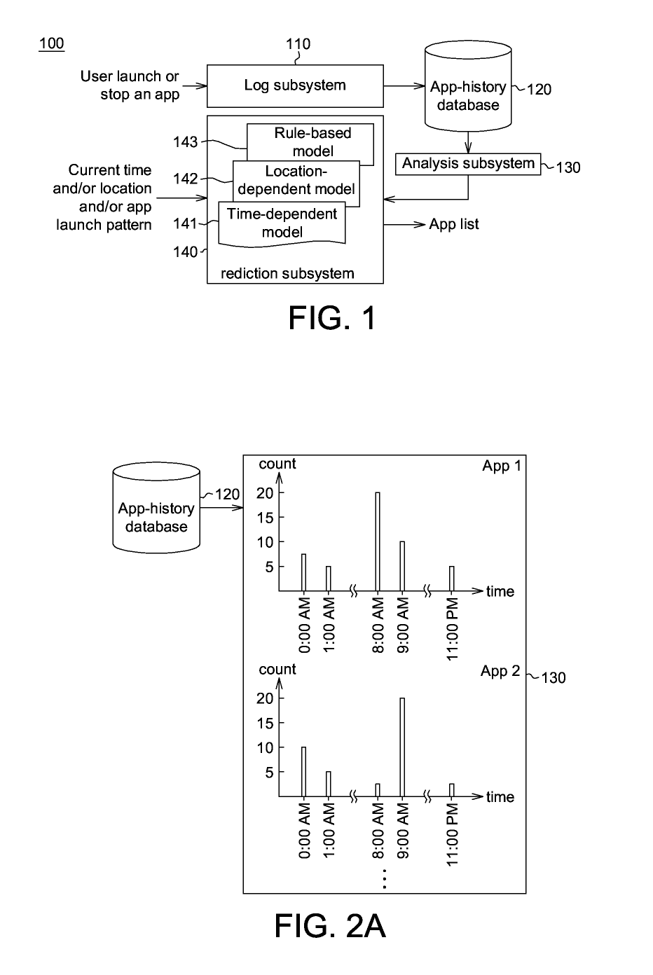

In this embodiment, a dynamic application list is predicted based on user behavior. Referring FIG. 1, functional block diagram for a portable electronic device according to an embodiment of the application is shown. The portable electronic device 100 according to the embodiment at least includes a log subsystem 110, an application history database 120, an analysis subsystem 130 and a prediction subsystem 140. In the following, the subsystems 110, 130 and 140 may be implemented by software, hardware, firmware or any combination, which is still within the spirit and scope of the application. The portable electronic device 100 according to the embodiment of the application provides an application list on a screen (not shown). That is to say, the application(s) that is/are most likely used by the user is predicted based on the application usage history. This implies that the present embodiment constructs or predicts user behavior on operating the portable electronic device. Thus, an application list is provided, so that the user can conveniently activate applications from the application list. In this way, convenience on operation the portable electronic device is enhanced.

The log subsystem 110 logs user behavior into the application history database 120. For example, the log subsystem 110 logs when and/or where the user launches which applications and/or the application launch patterns. For example, if the user launches an e-mail application at 9:00 AM at his office, then the subsystem 110 logs that the e-mail application is launched 9:00 AM at his office. For another example, if the user often launches calendar application after e-mail application, the subsystem 110 will also log this user application launch pattern.

In the embodiment, as known, there are many ways to obtain time information and location information. For example, but not limited, time information or location information may be provided by a detection unit (not shown), which may be realized by detection elements for detecting time information, and/or detection elements for detecting location information, and/or a combination thereof. For example, the detection unit may include a cell identity (cell-ID) detector, a global positioning system (GPS), and a wireless network connector. The cell-ID detector provides cell-ID information as the location information of the portable electronic device. The global positioning system provides GPS positioning information as location information of the portable electronic device. The wireless network connector provides address information of a wireless access point as location information of the portable electronic device. The way of obtaining time information is exemplified below. For example, server time provided by telecommunication services may be obtained by the cell-ID detector from telecommunication circuit (not illustrated). For another example, satellite time related to GPS positioning information may be obtained by the global positioning system. Internet time may be obtained by the wireless network connector. For another example, system time of the portable electronic device may be as time information. Thus, through suitable design of various application events, the portable electronic device constructs or predicts user's behavior by analyzing the application usage history APP-UH stored in the application history database 120, and predicts which application(s) is/are most likely to be used by the user at the current time or location.

The application history database 120 stores an application usage history APP-UH indicative of execution histories of the applications. The application usage history APP-UH includes for example (1) time information of the application event; and/or (2) location information of the application event; and/or (3) user application launch pattern. In other words, when an application event occurs, (1) time information of the application event; and/or (2) location information of the application event; and/or (3) user application launch pattern will be stored to the application history database 120 and recorded as the application usage history APP-UH. The application event is for example an event that an application is activated (i.e. an application activation event), an event that an application is terminated (i.e. an application termination event), or an event that an application is in use.

In an example, the application activation event is exemplified as an event that an application is activated. For further illustration, when a user activates an application, time and location at which the application is activated is logged by the log subsystem 110 into to the application-history database 120. For example, if the user activates an Internet application to browse webpages during his/her commute path, then the information related to when and/or where the Internet application is activated logged by the log subsystem 110 into to the application-history database 120 such that the portable electronic device 100 analyzes the application history data as to predict the user's behavior.

In another example, application event is exemplified as an event that an application is activated and another event that the application is terminated. That is similar to the above example in that when the user activates an application, the information related to when and/or where the application is activated is logged by the log subsystem 110 into to the application-history database 120; and further, when the user terminates the application, the information related to when and/or where the application is terminated is also logged by the log subsystem 110 into to the application-history database 120.

The application history database 120 keeps application usage history APP-UH happened within a period (for example but not limited 3 months). Thus, along with the user's operation, the content of the application usage history APP-UH is updated and the stored data is used in analyzing and predicting the user's behavior so that the prediction is closer to the user's recent habit in using the applications. However, events are for illustration and explanation, and the disclosure is not limited thereto. Where there is an event from which a user's behavior in using the applications can be properly predicted, such an event can be regarded as a predetermined event of the disclosure.

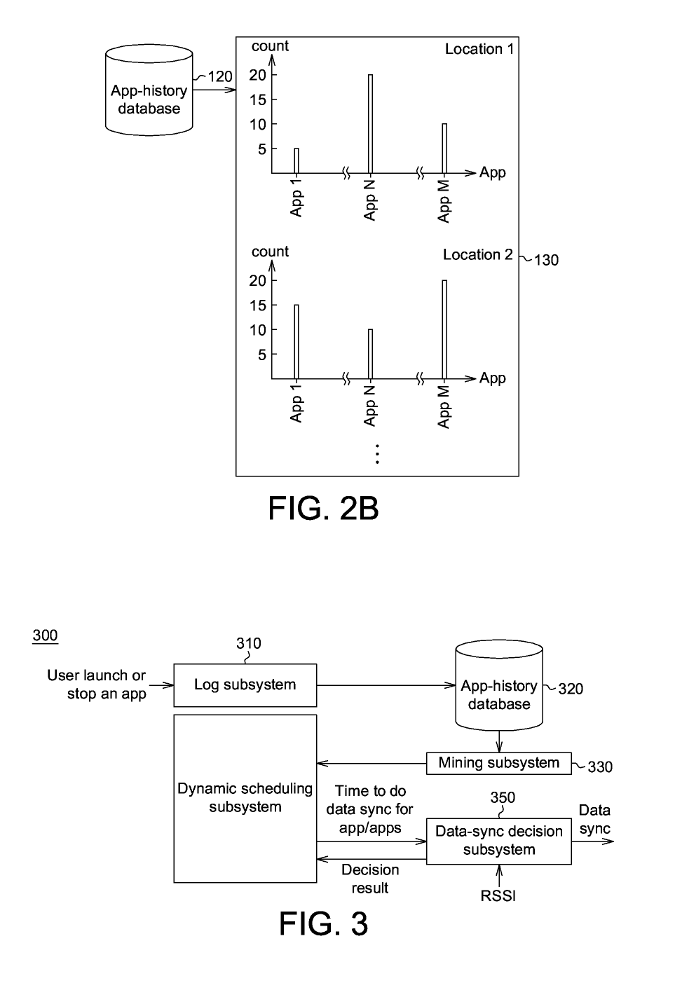

The analysis subsystem 130 analyzes relationship between user application usage behavior, time, location and application launch patterns. FIGS. 2A and 2B show analysis result examples of the analysis subsystem 130. After analysis, the analysis subsystem 130 builds the distribution of launch of all applications by for example but not limited histogram model.

As shown in FIG. 2A, the analysis subsystem 130 analyzes time information about when user launches application 1 and applications 2. For example, if the user launches the application 1 at 8:00 AM, then the count of the application 1 on 8:00 AM is added. In FIG. 2A, the X-axis is the time information (every time slot is 1 hr) and the Y-axis is the count information. FIG. 2A shows that for example, during the past 3 months, at 8:00 AM, application 1 is launched 20 times (which is the most frequently); and at 9:00 AM, application 2 is launched 20 times (which is the most frequently).

As shown in FIG. 2B, the analysis subsystem 130 analyzes location information about where user launches applications. For example, if the user launches the application 1 at location 1 (his office), then the count of the application 1 at location 1 is added. In FIG. 2B, the X-axis is the application information and the Y-axis is the count information. FIG. 2B shows that for example, at location 1 (user office), application N is launched 20 times (the most); and at location 2 (user home), application M is launched 20 times (the most).

The prediction subsystem 140 may selectively have 3 engines 141˜143 and of course, it is not necessary to includes all 3 engines. The first engine is a time-dependent model engine 141. For example, if the current time is 6:00 PM on Saturday, the time-dependent model engine 141 of the prediction subsystem 140 finds out what application(s) the user often launched near 6:00 PM on Saturday in the past based on the application history database 120 and provide a application list (selectively with probabilities). That is, the application list may list applications in the sequence based on probabilities. For example, application with highest probabilities is listed at top and so on.

The second engine is a location-dependent model engine 142. For example, if the portable electronic device knows that the user is in a restaurant, the location-dependent model engine 142 finds out what applications the user often launched in restaurants in the past from the application history database 120 and provides an application list with probabilities.

The third engine is a rule-based model engine 143. The rule-based model engine 143 constructs the association rules about application launch patterns from the application history database 120. For example, if the user often launches calendar application after mail application, the rule-based model engine 143 adds this pattern into rule. If the prediction subsystem 140 finds that the user now launches a mail application, the prediction subsystem 140 will assign higher probability for calendar application in this situation.

If the prediction subsystem 140 have more than one engine among engines 141˜143, the prediction subsystem 140 may have a combining engine to combine results from these engines 141˜143. A simple combining engine is the weighting sum of the probabilities provided by the time-dependent model engine 141 and/or location-dependent model engine 142 and/or rule-based model engine 143.

In other words, the prediction subsystem 140 may select from applications an application or applications that is/are most possible to be requested by the user according to the application usage history APP-UH, and any combination of the current time information, the current location information and the user application launch pattern.

With this user's app-launched behavior learning system disclosed in the embodiment, application list may be dynamically displayed according the the predicted results from the prediction subsystem 140. Besides, the portable electronic device according to the embodiment may further recommend application shortcuts or folders for the user so that the user may conveniently choose application.

For further illustration, there is provided an implementation of selecting from the applications application(s) that has/have high execution probability. In this case, in view of the current time, it may be identified from the application usage history APP-UH that which application is activated most often at the current time. As such, the identified application is assigned with a highest execution possibility at the current time. For example, suppose that a user often activated a browser application to read news at 9.00 am. In this case, based on the application usage history APP-UH, the prediction subsystem 140 may identify that the user is very likely to activate the browser at 9.00 am and thus the portable electronic device may even automatically connect to the news website which the user often visited, without manual activation by the user. In other words, at 9.00 am, the prediction subsystem 140 regards the browser as the application that has a highest probability, and treats it as the application that is most possible to be requested for execution. For another example, suppose the user goes to certain place such as a school or a tutorial school to pick up children everyday, and activates a telephony application to make a phone call for a particular telephone number. In this case, based on the application usage history APP-UH, the prediction subsystem 140 may identify that the user is very likely to activate the telephony application around the location of the school or the tutorial school or even make a phone call for a particular telephone number. In other words, when the user is near to or arrives at the school or the tutorial school, the prediction subsystem 140 will regard the telephony application as the application that has a highest probability and treat it as most possible application to be requested for execution.

The above method using execution probabilities of applications and is disclosed for illustrating an embodiment. In other embodiments, the prediction subsystem 140 may analyze the application usage history APP-UH according to other data analysis methods, such as methods based on linear/non-linear classification algorithms or neural network, to construct the user's behavior and predict which application is most likely used by the user at the current time or the current location or the current application launch pattern.

The portable electronic device 100 may display one or more shortcut icons used to activate the predicted application(s) on the (locked or unlocked) screen. In an embodiment of activating an application, when the touch screen receives a predetermined slide operation or a predetermined click operation, the portable electronic device will be unlocked and activate the corresponding application of the shortcut icon.

In another embodiment of activating an application, when the touch screen receives the above predetermined slide operation or click operation, the portable electronic device is unlocked and provides a security verification procedure. Thus, in the present embodiment, only when security verification procedure is passed will the selected application be opened. Examples of information for passing the security verification procedure include: code information inputted via a keyboard or a touch screen, such as a string composed of English letters, numbers, or symbols; or a pattern information, also referred as the gesture input information, inputted by touching the touch screen along a sliding path, such as the information inputted when the user draws “Z” on the touch screen. However, the disclosure is not limited to the above exemplifications.

In an alternative embodiment of activating an application, the portable electronic device provides the abovementioned security verification procedure. When the security verification procedure is passed, the portable electronic device is unlocked and at the same time activates the corresponding application of the shortcut icon.

The above embodiments illustrate how to unlock a portable electronic device and activate an application. To lock the screen is for avoiding error operations on the portable electronic due to accidental touch. Lock of the screen may also be designed to possess security enhancement function. In practice, the lock screen, also referred as “idle screen”, has palm rejection function, but the disclosure is not limited thereto. In short, according to the present embodiment, a shortcut icon making the user conveniently activate an application is displayed on the lock screen, so that the convenience of use of the portable electronic device is increased, and the operation of the portable electronic device is made simpler and more efficient.

The present embodiment constructs the user's behavior and generates application list so as to achieve higher user convenience. In other words, the application history database stores the application usage history APP-UH related to the user's behavior related to when and/or where the user launches which application and/or user application launch pattern, for example, to activate an Internet application during commuting, to activate a telephony application when picking up children daily at fixed time or at a fixed location, or to activate a telephony application when feeling like making a phone call home weekly or daily at a fixed time, or to automatically activate calendar application after the e-mail application is launched. Thus, the portable electronic device according to the embodiment can predict what the user would like to do next or which application is most likely used. Then, the portable electronic device displays an application list (such as an Internet application or a telecommunication program) and related instructions or parameters (such as the website or the telephone number) so that the user can conveniently open the desired application.

### Second Embodiment

The portable electronic device according to the second embodiment of the present application logs when and/or where the user launched data-sync application(s) and arranges dynamic data-sync scheduling according to the user's app-usage behavior. Besides, whether the data-sync action is executed or not will also depend on the signal connection quality (for example, if the signal connection quality is not good enough, then the data-sync action is not performed).

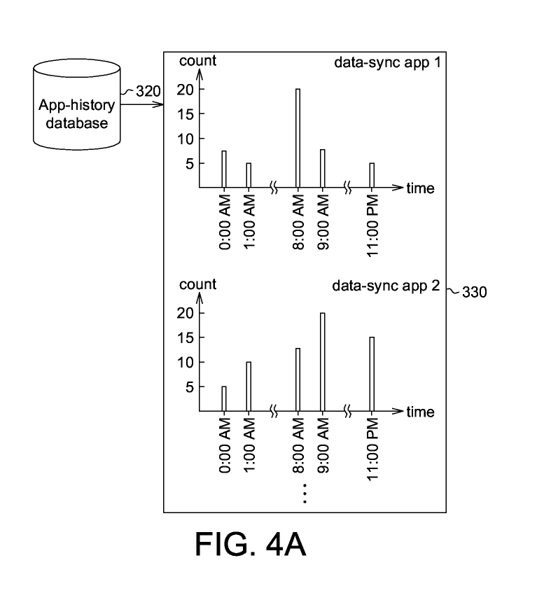

In this embodiment, data sync is scheduled based on user behavior and/or signal connection quality. FIG. 3 shows a functional block diagram of a portable electronic device 300 according to a second embodiment of the application. As shown in FIG. 3, the portable electronic device 300 at least includes a log subsystem 310, an application history database 320, a mining subsystem 330, a dynamic scheduling subsystem 340 and a data-sync decision subsystem 350.

The log subsystem 310 logs into the application history database 320 the launched time and/or location of the data sync application(s) such as email application(s), social network application(s), and etc that a user will consume the synced data.

The mining subsystem 330 finds out the time-dependent and/or location-dependent information (ex: probabilities) for the apps based on user behavior logged in the application history database 320. The mining subsystem 330 at least mines data based on any combination of a location-dependent model and a time-dependent model.

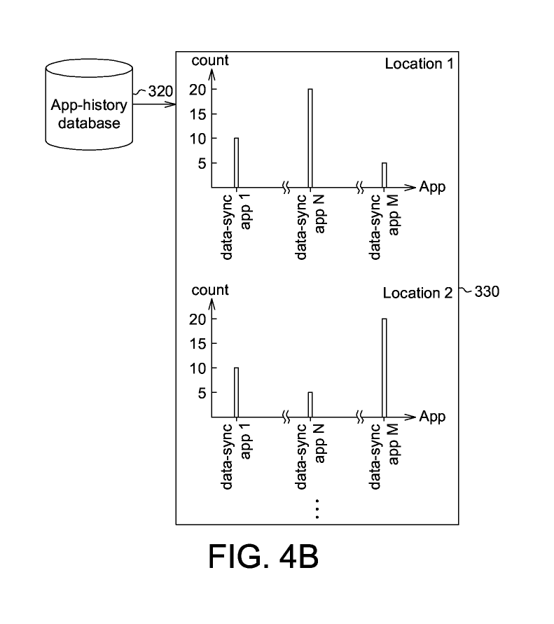

FIGS. 4A and 4B show data mining result from the mining subsystem subsystem 330. The mining subsystem 330 analyzes time information about when user launches data-sync application 1 (for example, e-mail) and applications 2 (for example, social networking browsing). For example, if the user launches the data-sync application 1 at 8:00 AM, then the count of the data-sync application 1 on 8:00 AM is added. In FIG. 4A, the X-axis is the time information and the Y-axis is the count information. FIG. 4A shows that for example, during the past 3 months, at 8:00 AM, data-sync application 1 is launched 20 times (the most frequently); and at 9:00 AM, data-sync application 2 is launched 20 times (the most frequently).

As shown in FIG. 4B, the mining subsystem 330 analyzes location information about where user launches data-sync applications. For example, if the user launches the data sync application 1 at location 1 (his office), then the count of the data sync application 1 at location 1 is added. In FIG. 4B, the X-axis is the data sync application information and the Y-axis is the count information. FIG. 4B shows that for example, at location 1 (user office), data sync application N is launched 20 times (the most frequently); and at location 2 (user home), data sync application M is launched 20 times (the most frequently).

The dynamic scheduling subsystem 340 schedules data-sync actions based on the mining results from the mining subsystem 330. A scheduling example is that the duration between 2 data-sync actions is a monotonic-decreasing function of the probabilities that user will launch the app at this time and/or location. For example, if the user did not read the email from 1:00 AM to 6:00 AM in the past, the dynamic scheduling subsystem 340 may use this information and do not do any email-sync in this duration. The dynamic scheduling subsystem 340 determines a time point to do data sync action.

However, in the application, in order to prevent unnecessary power consumption, after the time point to do data sync arrives, the data-sync decision subsystem 350 may decide whether to do this data sync action based on the signal connection quality. That is because the power consumption will become larger if the signal connection quality RSSI is bad. Therefore, if the signal connection quality RSSI is bad (ex: below a threshold), the data-sync decision subsystem 350 may decide to postpone or skip this data-sync action.

For example, suppose the user usually takes mass transit during commuting (8:00 AM˜9:00 AM) and in the mass transit, a detection result shows that the wireless signal connection quality is not good enough. If the dynamic scheduling subsystem 340 determines a data sync time point is 8:30 AM, based on the wireless signal connection quality RSSI, the data-sync decision subsystem 350 may decide to postpone or skip the data sync action scheduled at 8:30 AM.

Further, in other possible example of the application, data sync related to heavy-bandwidth-loading may be performed based on user behavior and (wireless) signal quality. For this, the mining subsystem 330 further includes an additional mining and content-downloading engine which logs and mines the user behavior about heavy-bandwidth-loading contents (such as downloading the attachments in the email or watching videos for the video link in the email or browsing social network sharing content). If the content-downloading engine finds that the user often consumes these heavy-bandwidth-loading contents with the probability higher than a threshold, the content-downloading engine will pre-fetch the heavy-bandwidth-loading contents if the wireless signal connection quality is good enough (ex: RSSI higher than a threshold). For example, usually, at home, the wireless signal connection quality is good enough and this information is also logged into the application history database 320. So, by the embodiment, the portable electronic device may prefetch heavy-bandwidth-loading contents (i.e. do data sync actions) at 7:30 at home so that when the user is during commuting, the user can conveniently consume heavy-bandwidth-loading contents. By this disclosure, data sync about heavy-bandwidth-loading contents will be performed at place/time with good wireless signal connection quality, rather than at place/time with low wireless signal connection quality.

The mining behaviors can be derived for more detail. For example, the mining subsystem 330 may mine the download behavior about receiving email or browsing social networking, etc. Further, the mining subsystem 330 may mine the download behavior about “who” send the email or “who” share the content. Further, the mining subsystem 330 may mine the download behavior about which kind of content the user usually download.

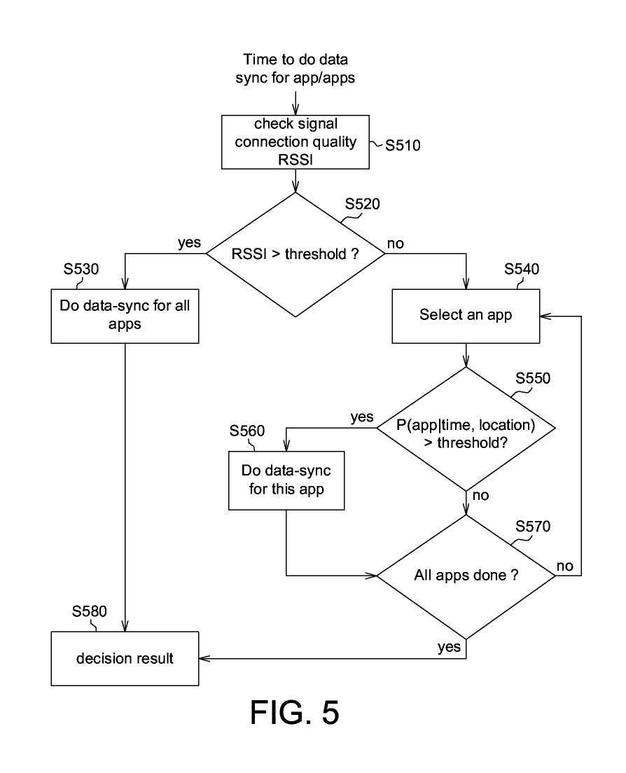

FIG. 5 shows data-sync decision flow chart according to the embodiment of the application. As shown in FIG. 5, if time to do data sync for app/apps arrives (for example, the dynamic scheduling subsystem determines that 8:00 AM for data sync), then, the data-sync decision subsystem check the signal connection quality RSSI, at step S510. At step S520, whether the signal connection quality RSSI is higher than a threshold is determined. If yes in step S520, then data sync for all applications is determined to be performed, as step S530. If no in step S520, then another application is selected, as step S540. In step S550, it is determined that P(app|time, location) is larger than a threshold or not. P(app|time, location) refers that, based on data mining result and dynamic scheduling result, launch probability for the data sync application under the time information and the location information. In other words, step S550 decides data sync for this application is to be performed or not. If yes in step S550, then data sync for this application is performed, as step S560. If not in step S550, then it is checked that data sync for all application is done or not, as step S570. At step S580, the dynamic scheduling subsystem 340 reports to the mining subsystem 330 decision result about whether to do data sync.

As discussed above, in the second embodiment of the application, provided is a data mining system which will log the data-sync app launch time and/or app launch location and arrange dynamic data-sync scheduling according to the user's app-usage behavior. Besides, whether the data-sync action is performed or not will also depend on the (wireless) signal connection quality, so to prevent downloading heavy-bandwidth-loading contents when the (wireless) signal connection quality is not good enough.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A control method for providing an application list on a portable electronic device, comprising:
logging an application usage history of a plurality of applications installed on the portable electronic device, the application usage history including any combination of when the applications are launched, where the application are launched and application launch patterns;
obtaining any combination of a current time information, a current location information and a current application launch pattern; and
selecting from the applications to provide the application list including at least one application that is possible to be launched according to the application usage history and any combination of the current time information, the current location information and the current application launch pattern.

2. The control method according to claim 1, wherein, the step of selecting the applications comprises:
generating probabilities for the applications according to the application usage history and any combination of the current time information, the current location information and the current application launch pattern; and
selecting applications having probability into the application list that is possible to be launched.

3. The control method according to claim 2, wherein:
based on the current time information and the application usage history, predicting which of the applications is likely to be launched based on a time-dependent model.

4. The control method according to claim 2, wherein:
based on the current location information and the application usage history, predicting which of the applications is likely to be launched based on a location-dependent model.

5. The control method according to claim 2, wherein:
based on the current application launch pattern and the application usage history, predicting which of the applications is likely to be launched based on a role-based model.

6. The control method according to claim 2, comprising:
combining probabilities provided by a time-dependent model and/or a location-dependent model and/or a rule-based model;
the time-dependent model predicting which of the applications is likely to be launched based on the current time information and the application usage history;
the location-dependent model predicting which of the applications is likely to be launched based on the current location information and the application usage history; and
the role-based model predicting which of the applications is likely to be launched based on the current application launch pattern and the application usage history.

7. A control method for a portable electronic device, including:
logging a data sync application usage history of a plurality of data sync applications installed on the portable electronic device, the data sync application usage history including any combination of when and where the data sync applications are launched;
mining the data sync application usage history for finding out dependent probabilities for the data sync applications;
scheduling data sync actions of the portable electronic device based on the mining; and
if time for the scheduled data sync actions arrives, deciding whether to perform the schedule data sync actions or not based on a signal connection quality of the portable electronic device.

8. The control method according to claim 7, wherein the mining step comprises:
mining the data sync application usage history based on any combination of a location-dependent model and a time-dependent model;
wherein mining the data sync application usage history about when the data sync applications are launched based on the time-dependent model; and
wherein mining the data sync application usage history about where the data sync applications are launched based on the location-dependent model.

9. The control method according to claim 7, wherein
if the mining indicates that synced data is not consumed within a duration, then data sync actions of the portable electronic device are not scheduled in the duration.

10. The control method according to claim 7, wherein:
if the signal connection quality is below a threshold, postponing or skipping the data-sync actions.

11. The control method according to claim 7, further comprising:
logging and mining user behavior about heavy-bandwidth-loading contents;
if consumption of the heavy-bandwidth-loading contents has a probability higher than a content consumption threshold, pre-fetching the heavy-bandwidth-loading contents if the signal connection quality is higher than a signal quality threshold.

12. The control method according to claim 11, further comprising:
mining content download behaviors about a content sender and a content sharer; and
mining the content download behaviors about which kind of content are downloaded.

13. A portable electronic device, comprising:
a log subsystem logging an application usage history of a plurality of applications installed on the portable electronic device, the application usage history including any combination of when the applications are launched, where the application are launched and application launch patterns;
means for obtaining any combination of a current time information, a current location information and a current application launch pattern; and
a predicting subsystem selecting from the applications to provide the application list including at least one application that is possible to be launched according to the application usage history and any combination of the current time information, the current location information and the current application launch pattern.

14. The portable electronic device according to claim 13, wherein:
the predicting subsystem generates probabilities for the applications according to the application usage history and any combination of the current time information, the current location information and the current application launch pattern; and
the predicting subsystem selects applications having probability into the application list that is possible to be launched.

15. The portable electronic device according to claim 14, wherein:
based on the current time information and the application usage history, the predicting subsystem predicts which of the applications is likely to be launched based on a time-dependent model.

16. The portable electronic device according to claim 14, wherein:
based on the current location information and the application usage history, the predicting subsystem predicts which of the applications is likely to be launched based on a location-dependent model.

17. The portable electronic device according to claim 14, wherein:
based on the current application launch pattern and the application usage history, the predicting subsystem predicts which of the applications is likely to be launched based on a role-based model.

18. The portable electronic device according to claim 14, further comprising:
a combination engine, combining probabilities provided by a time-dependent model engine and/or a location-dependent model engine and/or a rule-based model engine of the predicting subsystem;
the time-dependent model engine predicting which of the applications is likely to be launched based on the current time information and the application usage history;
the location-dependent model engine predicting which of the applications is likely to be launched based on the current location information and the application usage history; and
the role-based model engine predicting which of the applications is likely to be launched based on the current application launch pattern and the application usage history.

19. A portable electronic device, including:
a logging subsystem, logging a data sync application usage history of a plurality of data sync applications installed on the portable electronic device, the data sync application usage history including any combination of when and where the data sync applications are launched;
a mining subsystem mining the data sync application usage history for finding out dependent probabilities for the data sync applications;
a dynamic scheduling subsystem, scheduling data sync actions of the portable electronic device based on the mining; and
a data-sync decision subsystem, if time for the scheduled data sync actions arrives, deciding whether to perform the schedule data sync actions or not based on a signal connection quality of the portable electronic device.

20. The portable electronic device, according to claim 19, wherein:
the mining subsystem mines the data sync application usage history based on any combination of a location-dependent model and a time-dependent model;
the mining subsystem mines the data sync application usage history about when the data sync applications are launched based on the time-dependent model; and
the mining subsystem mines the data sync application usage history about where the data sync applications are launched based on the location-dependent model.

21. The portable electronic device according to claim 19, wherein
if the mining from the mining subsystem indicates that synced data is not consumed within a duration, then the dynamic scheduling subsystem does not schedule data sync actions in the duration.

22. The portable electronic device according to claim 19, wherein:
if the signal connection quality is below a threshold, the data-sync decision subsystem postpones or skips the data-sync actions.

23. The portable electronic device according to claim 19, further comprising:
the log subsystem and the mining subsystem logging and mining user behavior about heavy-bandwidth-loading contents;
if consumption of the heavy-bandwidth-loading contents has a probability higher than a content consumption threshold, the heavy-bandwidth-loading contents are pre-fetched if the signal connection quality is higher than a signal quality threshold.

24. The portable electronic device according to claim 23, wherein
the mining subsystem mines content download behaviors about a content sender and a content sharer; and
the mining subsystem mines the content download behaviors about which kind of content are downloaded.
